(19) United States
(12) Patent Application Publication
(10) Pub. No.: US 2006/0067301 A1
(43) Pub. Date: Mar. 30, 2006

(54) Forcing V.34 fax terminals to fallback to legacy G3 modulations over voice over intrnet protocol networks

(76) Inventors: Frank E. Fruth, Gaithersburg, MD (US); Herman Lo, Boyds, MD (US)

Correspondence Address: TEXAS INSTRUMENTS INCORPORATED, P O BOX 655474, M/S 3999, DALLAS, TX, 75265, US

(21) Appl. No.: 10/954,758

(22) Filed: Sep. 30, 2004

(51) Int. Cl. H04J 3/22; H04J 3/16; H04L 12/66

(52) U.S. Cl. 370/352

(57) ABSTRACT

Gracefully forcing two V.34 fax devices to use legacy G3 modulations (e,g., V.21, V.27ter, V.29, V.17) when communicating over a packet network (e.g, voice over Internet Protocol (VoIP)network). To force an originating fax terminal 10 and receiving fax terminal 18 to fallback to legacy modulation procedures, transmission of a Call Menu (CM) “FAX” signal 54 transmitted by the originating fax device 10 is suppressed S38 at either the originating VoIP/FoIP gateway 12 or answering VoIP/FoIP gateway 16. The suppression of the CM signal 54 forces the answering V.34 fax device 18 to timeout and fallback to non-V.34 fax modulations S40 as if the calling terminal 10 was not V.34-capable. Likewise, upon detecting the non-V.34 fax signals, the originating V.34 fax device 10 will fallback to non-V.34 fax procedures S42. The two V.34 fax terminals will continue the fax transmission using non-V.34 modulations S44.

### CROSS-REFERENCE TO RELATED APPLICATIONS

None

### FIELD OF THE INVENTION

The present invention relates generally to real-time facsimile transmissions over a packet network, and more specifically involves a technique for gracefully forcing two V.34 fax devices to use legacy modulations when communicating over a voice over Internet Protocol (VoIP) network.

### BACKGROUND OF THE INVENTION

A fax over packet application enables the interworking of standard fax machines with packet networks. The traditional method extracts the fax image from a fax machine's analog signal and carries it as digital data over the packet network. Packet networks that can be used to transport a fax include Internet (IP), Frame Relay, and ATM. Fax data in its original form is digital, however it is modulated and converted to analog for transmission over the public switched telephone network (PSTN). The fax over packet interworking functions reverses the analog conversion, instead transmitting digital data over the packet network, and then reconverting the digital data to analog for the receiving fax machine. This conversion process reduces the overall bandwidth required to send the fax because the digital form is much more efficient and allows for improved transmission reliability by employing mechanisms specific to fax for compensating packet network impairments.

Various protocols exist for transmission and receipt of facsimiles over low-delay analog voice-grade telephone lines. Once such protocol is Group 3 (G3), defined in Recommendation T.30, “Procedures for document facsimile transmission in the general switched telephone network”, which is hereby incorporated herein by reference. T.30 is an International Telecommunication Union (ITU) recommendation for facsimile transmissions over a telephone network. The T.30 protocol describes the formatting of non-page data, such as messages that are used for capabilities negotiation. The recommendation defines three different protocols for facsimile transfer, Group 1, 2 and 3. Only Group 3 (G3) is in common use today.

Over recent years, the deployment of V.34 fax devices has been growing as the cost to the consumer has as dropped. V.34 fax devices offer consumers increased transmission speeds which offset the bandwidth cost of advanced image coding features. A V.34 fax session uses V.34 Half-duplex physical layer modulation to exchange both T.30 control information as well as image data. This is markedly different from legacy G3 fax devices which used V.21 modulation for T.30 control information exchange and V.27, V.29, or V.17 for image data transmission.

While the G3 protocol is defined for analog transmission, the backbone network for modern telephone systems is generally digital. In addition, the ITU Recommendation T.38 “Procedures for real-time Group 3 facsimile communication over IP networks” defines realtime protocols for transmission of realtime fax over an IP network. When facsimile devices are connected through a packet-based network, such as packet, ATM, or Frame Relay, the sending and receiving devices are not directly connected. In a packet network, the facsimile information is packetized at a sending end, sent over the packet network, and reassembled into a facsimile format at the receiving end before presentation to the receiving facsimile device. The connection over a packet network experiences packet delays, jitter errors, and/or loss that must be hidden from the facsimile device by a gateway in order to ensure reliability of the fax transmission.

Most fax relay support deployed today is currently limited to non-V.34 fax transmissions. The capability for V.34 fax relay has only recently been standardized. As a result, today, V.34 fax relay calls are treated by a gateway identically as a high-speed data modem call using an operational mode typically referred to as Voice-Band Data (VBD). VBD consists of using a high data rate codec (e.g., G.711) that causes minimum signal distortion and is appropriate for passing modem signals. VBD modes of operation have higher network bandwidth utilization and are not as robust as fax relay techniques to packet network impairments (e.g., packet loss).

Even with the standardization of V.34 fax relay techniques, the V.34 fax relay capability comes with a high implementation cost (e.g., memory) due to the complexity of the V.34 modulation standard.

### SUMMARY

In some instances, it may be desirable to have low-cost product solutions not having V.34 support, but having the capability to exploit the bandwidth efficiency and robustness of fax relay techniques by forcing V.34 fax devices to lower modulations. The preferred embodiment includes a technique for gracefully forcing two V.34 fax devices to use legacy modulations (e.g., V.21, V.27ter, V.29, V.17) when communicating over a packet network (e.g., voice over Internet Protocol (VoIP) network). Advantages of this approach include the benefit of allowing effective alternative solutions to supporting V.34 fax terminals over VoIP networks. Instead of implementing conventional V.34 fax relay support, a gateway can employ the present invention described by this paper to provide an alternative solution for handling V.34 fax terminals.

Advantages of the present invention include packet network impairment robustness over standard VBD techniques, lower network bandwidth utilization than VBD techniques, and lower implementation cost than a V.34 fax relay solution. The present invention also allows a VoIP network to continue to support data modems through standard VBD techniques.

### BRIEF DESCRIPTION OF THE DRAWINGS

Preferred embodiments of the invention are discussed hereinafter in reference to the drawings, in which:

FIG. 1 illustrates the standard fax relay topology on an IP (Internet Protocol) network;

FIG. 2 illustrates the standard V.34 phase 1 start-up exchange between two V.34 fax terminals;

FIG. 3 flowchart showing the preferred method for V.34 fax terminals to fallback to legacy G3 modulations;

FIG. 4 illustrates the signal exchange between the fax terminals and gateways for the case that the originating gateway suppresses the CM signal;

FIG. 5 illustrates the signal exchange between the fax terminals and gateways for the case that the answering gateway 16 suppresses the CM signal.

### DETAILED DESCRIPTION OF PREFERRED EMBODIMENTS

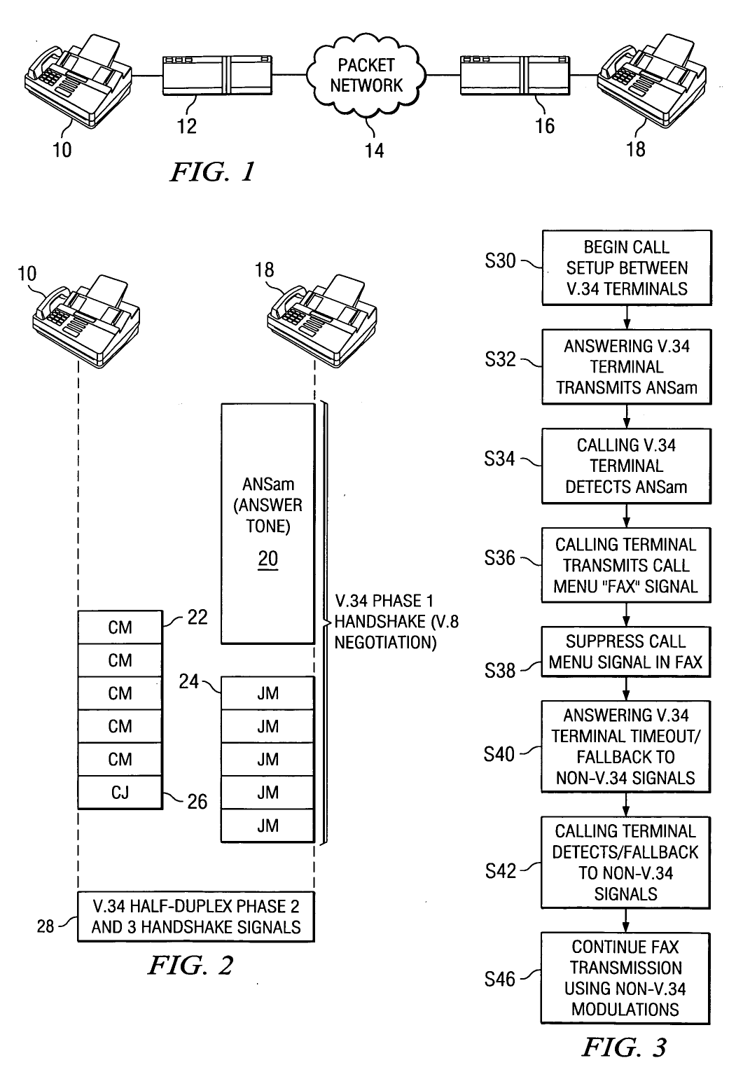

The preferred embodiment of the present invention is a technique for gracefully forcing two V.34 fax devices to use legacy modulations (e,g., V.21, V.27ter, V.29, V.17) when communicating over a VoIP (voice over Internet Protocol) network. FIG. 1 illustrates the standard fax relay topology on an IP (Internet Protocol) network. Facsimile device 10 sends and receives faxes to far-end facsimile device 18 through Packet Network 14. Packet network 14 may include any broadband network. Voice over packet/fax over packet (VoP/FoP) Gateway 12 is connected to packet network 14. Gateway 12 connects to the packet network with a high speed Internet connection such as a digital subscriber line (DSL), cable modem, or T1/T5 line. Gateway 12 uses a codec to convert analog fax data from fax device 10 into digital format, using protocols such as pulse code modulation (PCM) or ITU T.38 “Procedures for real-time Group 3 facsimile communication over IP networks”, which is incorporated herein. Packetized facsimile data is then transmitted to far-end VoP/FoP gateway 16 that converts the digital data back to analog format for reception by facsimile terminal 18.

FIG. 2 illustrates the standard V.34 phase 1 start-up exchange between two V.34 fax terminals. In the first step, a call setup procedure is initiated by the calling/originating V.34 fax terminal 10. Upon going off-hook, the answering/receiving V.34 fax terminal 18 transmits modified answer tone (ANSam) 20 to the calling fax terminal 10. Detection of the ANSam signal by the calling V.34 fax terminal 10 indicates that the receiving fax terminal 18 is V.34 capable. In response, the calling V.34 fax device 10 transmits a V.8 defined Call Menu (CM) signal 22 in accordance with the V.34/V.8 procedures. A CM signal 22 identifies the capabilities of the calling terminal. The CM signal 22 will also identify the terminal 10 as a fax device. The answering terminal 18 detects and decodes the CM signal 22 and responds with a Joint Menu (JM) signal 24. The JM signal 24 identifies the common set of capabilities supported by both devices. Upon receiving the JM signal 24, the calling fax terminal 10 transmits a CM terminator signal 26, shown as CJ in FIG. 2, which acknowledges the reception of the JM signal 24. This completes phase 1 of the V.34 handshake sequence. The calling 10 and answering 18 fax terminals next proceed to phase 2 and continue through the rest of the handshake sequence until the two terminals enter V.34 control channel data mode.

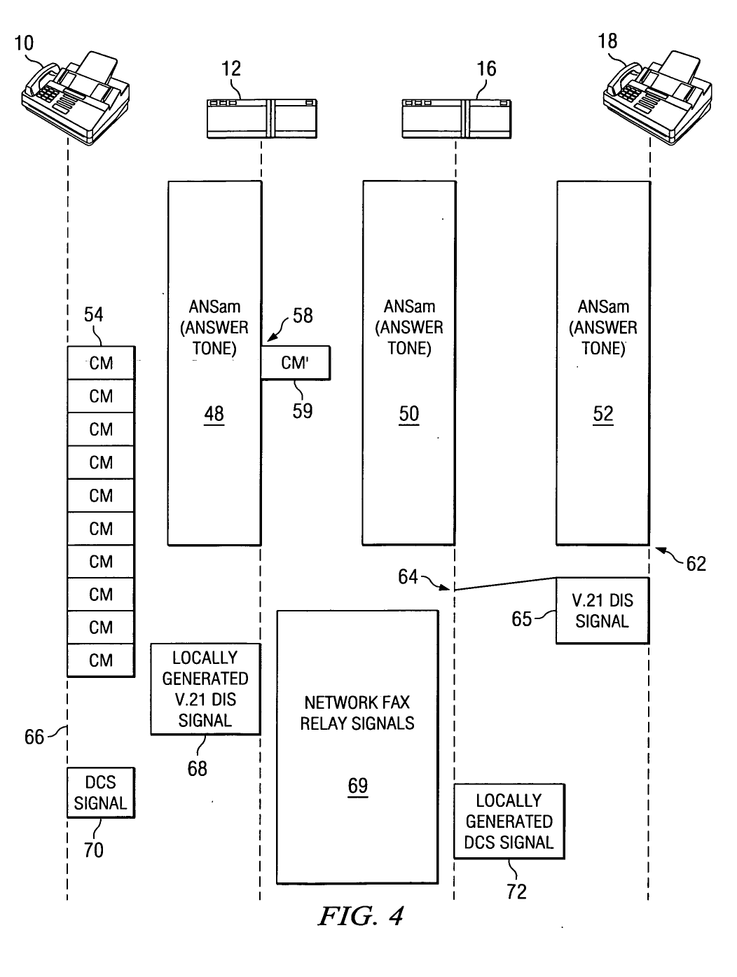

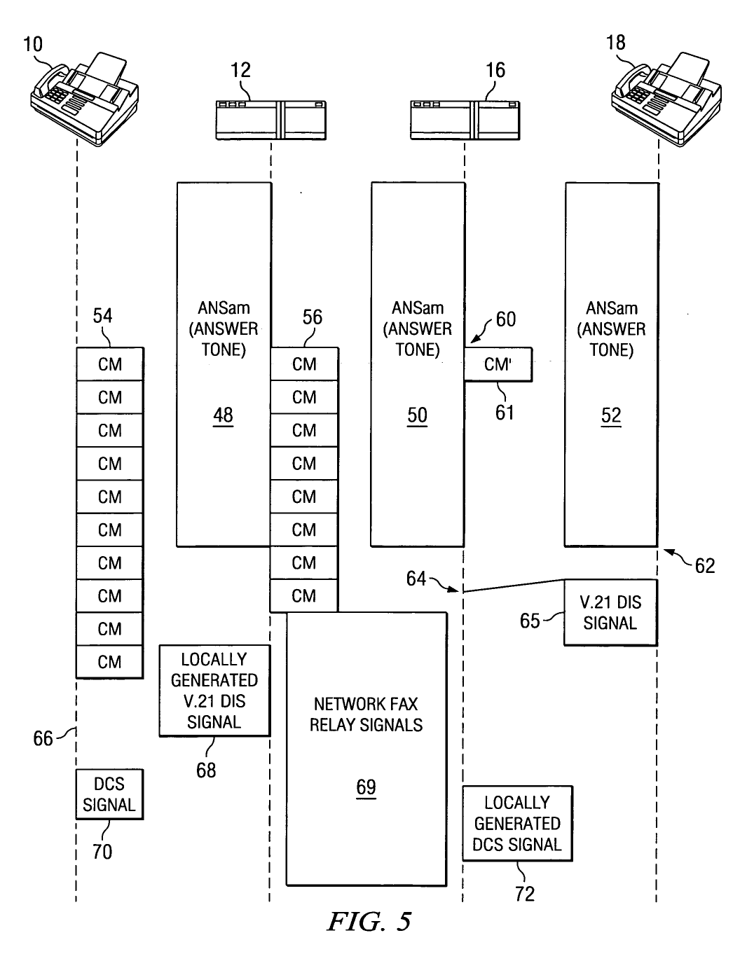

The preferred techniques for forcing V.34 fax terminals to fallback to legacy G3 modulations is illustrated in the flowchart of FIG. 3 and diagrams of FIGS. 4 and 5. FIG. 4 and FIG. 5 show the exchange of signals between two V.34 fax terminals and corresponding VoP/FoP VoIP gateways. FIG. 4 shows the signal exchange between the fax terminals and gateways for the case that the originating gateway 12 suppresses the CM signal. FIG. 5 shows the signal exchange between the fax terminals and gateways for the case that the answering gateway 16 suppresses the CM signal. Differences in the two procedures will be explained where they occur.

After the answering V.34 fax terminal 18 goes off-hook and initiates a setup procedure S30 with the calling V.34 fax terminal 10, answering terminal 18 transmits an answer tone 52 that passes transparently as ANSam 50 through gateway 16 and as ANSam 48 through gateway 12 using the audio codec S32. Detection of the ANSam signal S34 by calling V.34 fax terminal 10 indicates that the answering fax terminal 18 is a V.34 fax terminal. The calling V.34 fax terminal 10 transmits a V.8 CM signal S36 to the answering V.34 terminal 18. In FIG. 4, VoP gateway 12 detects the V.8 Call Menu (CM) signal 54 from the direction of calling V.34 fax terminal 10 transmitting over time division multiplex (TDM) protocols. In FIG. 5, VoP gateway 16 detects the V.8 Call Menu (CM) signal from the packet network 14 direction. Depending on the case, gateway 12 and/or gateway 16 decodes and interprets the content of the CM signal received and determines whether the call function is FAX. A fax call is determined by whether the call function category is set to “Receive facsimile” or “Transmit facsimile” as define in the V.8 standard.

To force originating fax terminal 10 and receiving fax terminal 18 to fallback to legacy modulation procedures, transmission of the CM “FAX” signal 54 transmitted by the originating fax device is suppressed S38 at either the originating VoIP/FoIP gateway 12 or answering VoIP/FoIP gateway 16. The suppression of the CM signal 54 forces the answering V.34 fax device 18 to timeout and fallback to non-V.34 fax modulations S40 as if the calling terminal 10 was not V.34-capable. Likewise, upon detecting the non-V.34 fax signals, the originating V.34 fax device 10 will fallback to non-V.34 fax procedures S42. Thus, the two V.34 fax terminals will continue the fax transmission using non-V.34 modulations S44. In the case of a data modem, the CM signal would be allowed to pass through the gateways.

Referring again to FIGS. 4 and 5, if the call function identified by the received CM signal is FAX, then gateway 12 suppresses transmission of the CM signal 58 minimizing the signal leakage prior to gateway suppression of the CM signal to at most 1 CM sequence 59. Similarly, gateway 16 suppresses transmission of “FAX” CM signal S38 at 60 minimizing the signal leakage prior to gateway suppression of the CM signal to at most 1 CM sequence 61. A receiving terminal needs to receive at least two valid CM sequences before it can respond with JM. Therefore, with leakage of maximum one CM sequence 59,61 an answering terminal cannot respond with a JM signal.

If the call function identified by the CM signal is not FAX, then the CM signal is allowed to pass toward the answering fax 18 transparently. The suppression of the CM signal to the answering V.34 fax terminal 18 by either the answering 16 or originating 12 gateways will force the answering V.34 fax terminal 18 to fallback to non-V.34 fax procedures S40. The answering V.34 fax terminal 18 will timeout and begin transmitting the fax control signals, using V.21 modulation 62. In accordance with T.30, answering terminal 18 will transmit a Digital Identification Signal (DIS) 70 to calling terminal 10 using V.21 modulation. A DIS signal is a signal sent by an answering fax terminal unit specifying the unit's capabilities. Answering gateway 16 and originating gateway 12, upon detecting the V.21 flag data sequence, will switch the gateway to fax relay processing 64. Gateway 16 and gateway 12 will begin trading network fax relay signals 68.

Next, originating gateway 12 will transmit a locally generated V.21 to originating V.34 fax terminal 10. In response, the originating V.34 fax terminal 10 will fallback to legacy G3 fax procedures upon receiving V.21 fax signals 66 (S42). Gateway 12 and/or gateway 16 must ensure that Bit 6 of the DIS fax control signal is set to zero. This bit indicates that the gateway is V.8 capable and thus V.34 capable. If set, a fax terminal could attempt to go back and re-attempt V.34 start-up procedures.

After the originating fax terminal 10 and receiving fax terminal 18 are transmitting legacy G3 fax signals, the fax transmission is then continued using non-V.34 modulations S46.

The present invention offers the advantages of allowing effective alternative solutions to supporting V.34 fax terminals transmitting data over packet (e.g., VoIP) networks. The invention provides packet network impairment robustness exceeding standard voice band data (VBD) techniques. Further, the present invention has lower network bandwidth utilization than VBD methods, has lower implementation costs than a V.34 fax relay solution, and allows a VoIP network to continue to support data modems through standard VBD techniques.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A method for forcing V.34 facsimile terminals to fallback to legacy modulation protocols, comprising:
connecting an originating V.34 facsimile terminal to an originating voice over packet gateway;
connecting a receiving V.34 facsimile terminal to a receiving voice over packet gateway, wherein said originating gateway and said receiving gateway are connected over a packet network;
transmitting, during a start-up procedure, a call menu signal from said originating V.34 facsimile terminal to said receiving V.34 facsimile terminal;
suppressing said call menu signal prior to reception by said receiving V.34 facsimile terminal.

2. The method of claim 1, wherein said suppressing comprises said originating gateway suppressing the transmission of the call menu signal.

3. The method of claim 2, further comprising:
minimizing leakage of said call menu fax signal past said originating gateway to at most a single sequence of said call menu signal.

4. The method of claim 1, wherein said suppressing comprises if said call menu signal is a call menu FAX signal, then said originating gateway suppresses the transmission of the call menu fax signal.

5. The method of claim 1, further comprising:
switching said receiving facsimile terminal protocols to use non-V.34 modulation signals;
transmitting said non-V.34 modulation signals from said receiving facsimile terminal to said receiving gateway; and
switching, at said receiving gateway, to fax relay processing protocols after reception of said non-V.34 modulation signals transmitted by said receiving facsimile terminal.

6. The method of claim 5, further comprising:
generating, at said originating gateway, non-V.34 modulation signals after reception of said fax relay processing protocols from said originating gateway;
transmitting said non-V.34 modulation signals generated at said originating gateway to said originating facsimile terminal; and
switching said originating facsimile protocols to use non-V.34 modulation signals.

7. The method of claim 1, wherein said non-V.34 modulation signals generated at said originating gateway comprise a non-V.34 digital identification signal (DIS) from said originating gateway, wherein bit six of the DIS is set to zero.

8. The method of claim 1, wherein said suppressing comprises said receiving gateway suppressing the transmission of the call menu signal.

9. The method of claim 8, further comprising:
minimizing leakage of said call menu fax signal past said receiving gateway to at most a single sequence of said call menu signal.

10. The method of claim 1, wherein said suppressing comprises if said call menu signal is a call menu FAX signal, then said receiving gateway suppresses the transmission of the call menu fax signal.

11. A system for forcing V.34 facsimile terminals to fallback to legacy modulation protocols, comprising:
an originating voice over packet gateway;
a receiving voice over packet gateway connected to said originating gateway over a packet network;
a receiving V.34 facsimile terminal to said receiving voice over packet gateway, wherein;
an originating V.34 facsimile terminal, connected to said originating voice over packet gateway, that transmits a call menu signal during a start-up procedure from said originating V.34 facsimile terminal to said receiving V.34 facsimile terminal;
wherein said receiving voice over packet gateway suppresses said call menu signal prior to reception by said receiving V.34 facsimile terminal.

12. The system of claim 11, wherein said originating gateway suppressing the transmission of the call menu signal.

13. The system of claim 12, wherein said originating gateway minimizes leakage of said call menu fax signal past said originating gateway to at most a single sequence of said call menu signal.

14. The method of claim 13, wherein said originating gateway suppresses the transmission of the call menu fax signal if said call menu signal is a call menu FAX signal.

15. The method of claim 11, wherein said receiving facsimile terminal switches protocols to use non-V.34 modulation signals, and
transmits said non-V.34 modulation signals to said receiving gateway.

16. The method of claim 15, wherein said originating gateway
generates non-V.34 modulation signals after reception of said fax relay processing protocols from said originating gateway, and
transmits said non-V.34 modulation signals generated at said originating gateway to said originating facsimile terminal.
